(19) United States
(12) Patent Application Publication
(10) Pub. No.: US 2010/0123665 A1
(43) Pub. Date: May 20, 2010

(54) Displays for Mobile Devices that Detect User Inputs Using Touch and Tracking of User Input Objects

(76) Inventor: Jorgen Birkler, San Mateo, CA (US)

Correspondence Address: MYERS BIGEL SIBLEY & SAJOVEC, P.A., P.O. BOX 37428, RALEIGH, NC, 27627, US

(21) Appl. No.: 12/271,239

(22) Filed: Nov. 14, 2008

(51) Int. Cl. G06F 3/041

(52) U.S. Cl. 345/173

(57) ABSTRACT

A mobile device includes a touch-sensitive display screen including an array of electromagnetic radiation detectors. The array of electromagnetic radiation detectors is configured to generate an image of a user input object when the user input object is spaced apart from the display, and the touch-sensitive display is further configured to generate a touch signal in response to the display screen being touched by the user input object. The mobile device further includes a controller configured to identify use input gesture from a combination of the image of the user input object and the touch signal.

### RELATED APPLICATION

This application is related to co-pending and commonly assigned U.S. application Ser. No. 12/250,108, entitled “User Input Displays For Mobile Devices,” filed Oct. 13, 2008, the disclosure of which is incorporated herein by reference.

### BACKGROUND

The present invention relates to displays for a mobile device, and in particular, to displays for receiving user input.

Various technologies are available to detect stylus and/or finger contact in touch sensitive displays. For example, a resistive touchscreen panel includes two spaced-apart, thin metallic electrically conductive and resistive layers. When a user input object touches the panel, the layers are connected, causing a change in an electrical current. This change in electrical current is detected as a user input contact event. Resistive touchscreens are typically relatively precise, but may not be sufficiently sensitive, especially if the user's finger is used to contact the touch screen.

A capacitive touchscreen is typically coated with a material, such as indium tin oxide, that conducts a continuous electrical current across a sensor. The sensor exhibits a controlled field of stored electrons in both horizontal and vertical axes to achieve a capacitance. When the sensor's capacitance field is altered by another capacitance field, e.g., a user's finger, electronic circuits located at each corner of the panel measure the distortion and identify a location of the disturbance. Capacitive touch screens have a relatively high sensitivity, but the precision with which the location of the event is detected can be low.

A side-optical touchscreen uses a grid of optical detectors on top of the surface of the display. Light is sent from one side to the other and received by detectors both horizontally and vertically. The beams of light are broken when a finger or stylus is in close proximity such that the location can be translated into coordinates by the detectors. However, since the light sources and the detectors need to be placed on top of the display, this configuration builds height that is generally not desirable in mobile devices.

Another type of optical touchscreen uses the total internal reflection principle. A refractive medium is filled with light, and when a finger or other object is pressed against the surface, the internal reflection light path is interrupted, which results in light being reflected outside of the refractive medium. The light outside the refractive medium can be detected by a camera. Refraction-optical touchscreens generally have good sensitivity and precision. However, the space required for light sources and the refractive medium may increase the dimensions of the display and also limit the contrast of the display because it is combined with a camera, and therefore, this type of optical touchscreen may not be practical for use with hand-held devices.

Moreover, touchscreens may not be able to operate using the same general protocols as a mouse-based user interface because user inputs may be generated only upon contact with the screen. Thus, it may be more difficult for a user to track movement of an icon, for example, to select a region, than can be accomplished with a mouse. However, a mouse input device may not be desirable to use with a compact, hand-held device.

### SUMMARY

A mobile device according to some embodiments includes a touch-sensitive display screen including an array of electromagnetic radiation detectors. The array of electromagnetic radiation detectors is configured to generate an image of a user input object when the user input object is spaced apart from the display, and the touch-sensitive display is further configured to generate a touch signal in response to the display screen being touched by the user input object. The mobile device further includes a controller configured to identify a user input gesture from a combination of the image of the user input object and the touch signal. The controller is further configured to identify a hotspot on the user input object. The hotspot may include a portion of the user input object at which contact between the user input object and the display screen is expected.

The controller is further configured to identify a user input gesture in response to a pre-condition, a trigger, and a post-condition, at least one of which may include detection of the hotspot while the user input object is spaced apart from the display screen and at least one other of which may include detection of the user input object touching on the display screen.

The controller may be further configured to identify at least one attribute of the hotspot, and to identify the user input gesture in response to the at least one attribute of the hotspot. The at least one attribute may include at least one of a position, angular orientation, radius and velocity of the hotspot.

The at least one attribute may include a distance of the hotspot from the display screen, and the controller may be configured to estimate the distance of the hotspot from the display screen from the image of the user input object.

The controller may be configured to measure an edge blurriness of the user input object in the image of the user input object, and to estimate the distance of the hotspot from the display screen in response to the edge blurriness of the user input object.

The controller may be further configured to identify a plurality of attributes of the hotspot, and to identify the user input gesture in response to the plurality of attributes of the hotspot.

The display may further include an electromagnetic radiation emitter configured to emit electromagnetic radiation in a direction away from the display, and the electromagnetic radiation detector may be configured to detect electromagnetic radiation reflected from the user input object in a direction toward the display. The electromagnetic radiation detector may be configured to detect thermal radiation from the user input object.

The controller may be configured to display an icon on the display responsive to the detection of the user input object. The controller may be configured to track movement of the user input object by displaying the icon in a region on the display screen responsive to movement of the user input object.

The controller may be configured to interpret a “select” command in response to a gesture including a precondition of a hotspot detection, a trigger of a touch signal indicating that the display screen was touched, and a postcondition of a hotspot detection.

The controller may be configured to interpret a “click” command in response to a gesture including a precondition of detection of a hotspot within a first threshold t_{click} seconds before the display screen is touched, a trigger of a touch signal indicating that the display screen was touched with a velocity w in a direction normal to the screen greater than a second threshold W_{click}, and a postcondition of a hotspot detection.

The controller may be configured to interpret a “drag” command in response to a gesture including a precondition of a hotspot detection and a first touch signal indicating that the display screen was touched, a trigger of movement of the hotspot, and a postcondition of a second touch signal indicating that the display screen continues to be touched.

The controller may be configured to interpret a “track” command in response to a gesture including a precondition of a hotspot detection, a trigger of movement of the hotspot, and a postcondition of a hotspot detection.

The controller may be configured to interpret a “flick” command in response to a gesture including a precondition of a hotspot detection and a first touch signal indicating that the display screen was touched, a trigger of movement of the hotspot with a horizontal velocity vector (u,v) larger than a threshold velocity, and a postcondition of a second touch signal indicating that the display screen is no longer touched.

The controller may be configured to interpret a “grab” command in response to a gesture including a precondition of detection of two hotspots and a first touch signal indicating that the display screen was not touched, a trigger of movement of the two hotspots together, and a postcondition of a second touch signal indicating that the display screen is no longer touched.

The controller may be configured to interpret a “drop” command in response to a gesture including a precondition of detection of one hotspot and a first touch signal indicating that the display screen was not touched, a trigger of separation of the single hotspot into two hotspots and a second touch signal indicating that the display screen is touched, and a postcondition of a third touch signal indicating that the display screen is no longer touched.

The controller may be configured to interpret a “sleep” command in response to a gesture including a precondition of detection of no hotspots and a touch signal indicating that the display screen was not touched, a trigger of an the image indicating that the entire display screen has been covered by a user's hand, and a postcondition of detection of no hotspots.

The controller may be configured to interpret a “wave” command in response to a gesture including a precondition of detection of no hotspots and a touch signal indicating that the display screen was not touched, a trigger of the image indicating that a hand was moved over the display screen from one side to another, and a postcondition of detection of no hotspots.

The controller may be configured to interpret an “answer” command in response to a gesture including a precondition of a first touch signal indicating that the display screen was not touched, and a trigger of the image indicating an ear adjacent to the display screen.

Some embodiments provide methods for detecting user input on a touch-sensitive display screen. The methods include generating an image of a user input object positioned adjacent to and spaced apart from the touch-sensitive display screen using an array of electromagnetic detectors in the display, generating a touch signal in response to the user input object touching the display screen, and identifying a user input in response to the image of the user input object and the touch signal.

The methods further include detecting a hotspot on the user input object that correspond to a portion of the user input object at which contact between the user input object and the display screen is expected. Identifying the user input is performed in response to a pre-condition, a trigger, and a post-condition, at least one of which may include detection of the hotspot while the user input object is spaced apart from the display screen and at least one other of which may include detection of the user input object touching on the display screen.

The methods may further include identifying a shape of the user input object from the image. Detecting the hotspot may be performed in response to the identified shape of the user input object.

The methods may further include identifying at least one attribute of the hotspot, and identifying the user input may be performed in response to the at least one attribute of the hotspot.

The methods may further include identifying a plurality of attributes of the hotspot, and identifying the user input may be performed in response to the plurality of attributes of the hotspot.

The attribute may include a distance of the user input object from the display screen, and identifying the attribute may include measuring an edge blurriness of the user input object in the image and estimating the distance of the user input object from the display screen in response the edge blurriness of the user input object.

A touch-sensitive display system according to some embodiments includes a touch-sensitive display screen including an array of electromagnetic radiation detectors. The array of electromagnetic radiation detectors is configured to generate an image of a user input object when the user input object is spaced apart from the display, and the touch-sensitive display is further configured to generate a touch signal in response to the display screen being touched by the user input object.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a front view of a mobile communications device having a display according to embodiments of the present invention.

FIG. 2 is an exploded view of the display of FIG. 1.

FIG. 3 is a cross sectional view of the display of FIG. 1.

FIG. 4 is a cross sectional view of a layer of the display of FIG. 1 including electromagnetic radiation emitters and detectors according to embodiments of the present invention.

FIG. 5A is a digital image of an electromagnetic radiation profile according to embodiments of the present invention.

FIG. 5B is an enhanced image derived from the image of FIG. 5A.

FIG. 5C is a schematic illustration of an identification of a user input device using the images of FIGS. 5A-5B.

FIG. 5D is a schematic illustration of a target region identified based on the illustration of FIG. 5C.

FIG. 6 is a flowchart illustrating operations according to embodiments of the current invention.

FIG. 7 is a cross sectional view of a touch-sensitive display according to some embodiments of the present invention.

FIG. 8 is a cross sectional view of another touch-sensitive display according to some embodiments of the present invention.

FIG. 9 is a flowchart illustrating operations according to embodiments of the current invention.

FIG. 10 is a schematic block diagram illustrating a wireless communication system with a wireless mobile communications device according to some embodiments of the invention.

FIG. 11 is a plan view of a display according to further embodiments.

FIG. 12 is a schematic illustration of a pixel of a display according to further embodiments.

FIG. 13 is a flowchart illustrating operations according to embodiments of the current invention.

FIG. 14 illustrates digital images of user input objects according to various embodiments.

FIG. 15 illustrates some attributes of a hotspot that can the captured and characterized according to some embodiments.

### DETAILED DESCRIPTION

The present invention now will be described hereinafter with reference to the accompanying drawings and examples, in which embodiments of the invention are shown. This invention may, however, be embodied in many different forms and should not be construe is limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to. “coupled” with, “contacting,” etc., another element, it call be directly oil, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

As used herein, a “mobile terminal” includes, but is not limited to, a terminal that is configured to receive communication signals via a wireless interface from, for example, a cellular network, a Wide Area Network, wireless local area network (WLAN), a GPS system, and/or another RF communication device. Example mobile terminals include, but are not limited to, a cellular mobile terminal; a GPS positioning receiver; an acceleration measurement device with a wireless receiver; a personal communication terminal that may combine a cellular mobile terminal with data processing, facsimile and data communications capabilities; a personal data assistance (PDA) that can include a wireless receiver, pager, Internet/intranet access, local area network interface, wide area network interface, Web browser, organizer, and/or calendar; and a mobile or fixed computer or other device that includes a wireless receiver.

As used herein, a “display” includes, but is not limited to, a device capable of providing a visual representation, such as graphics, lighting or back-lighting for displaying information and/or for aesthetic purposes.

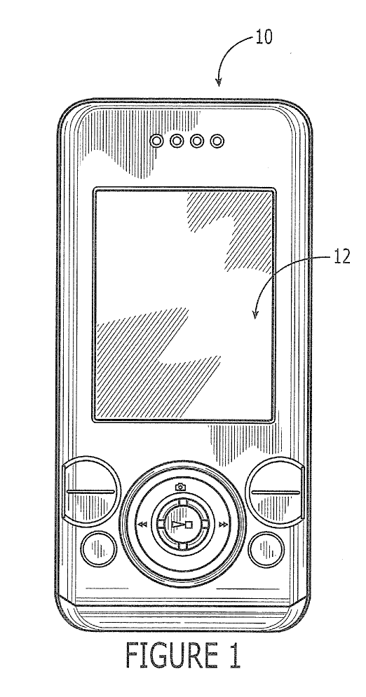

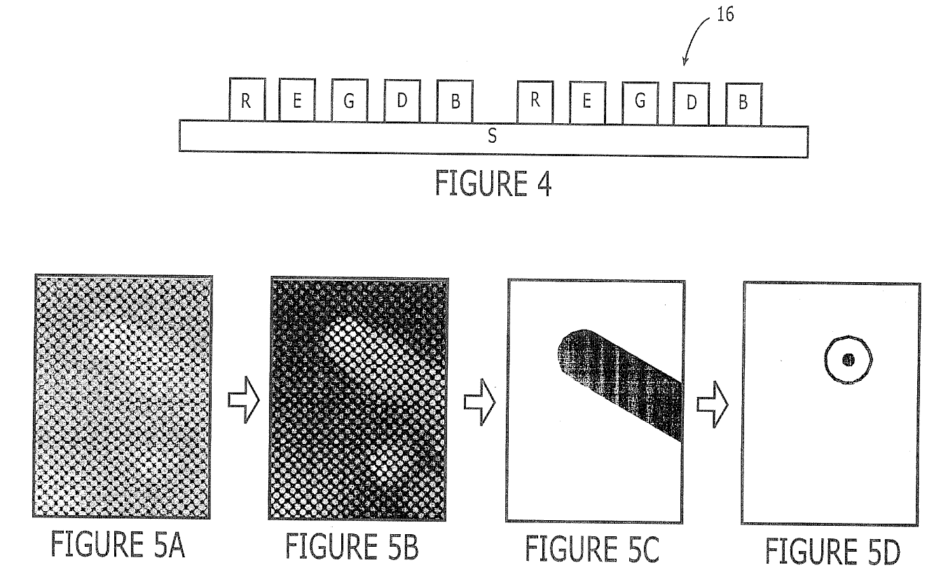

As illustrated in FIGS. 1-3, a hand-held mobile device 10 includes a liquid crystal diode (LCD) display 12. The display 12 includes a backlighting layer 14, a liquid crystal layer 16, a protective layer 18 (such as glass) and a touch panel layer 20. As illustrated in FIG. 4, an alternative configuration employing organic light emitting diodes (OLEDs) can be used in which the backlighting layer 14 and/or the liquid crystal layer 16 are omitted. The display 12 of FIG. 4 includes an array of electromagnetic radiation emitters E and electromagnetic radiation detectors D on a substrate S. In some embodiments, the electromagnetic radiation emitters E and electromagnetic radiation detectors D may include infrared emitters and detectors, respectively. The substrate S also includes light emitters R, G and B, such as light emitting diodes (LEDs) or OLEDs, that are used to display pixels of various colors on the display 12.

As shown in FIG. 3, the emitters emit electromagnetic radiation ER away from the display 12. If a user input object 22, such as a finger, is positioned adjacent to (although not necessarily in contact with) the display 12, then the electromagnetic radiation ER is reflected in a direction toward the display 12. The reflected electromagnetic radiation ER can be detected by the detectors D within and/or beneath the liquid crystal layer 16. Contact between the user input object 22 and the display is not required, and the electromagnetic radiation EAR can be reflected by the object 22 when the object 22 is spaced apart from the display 12.

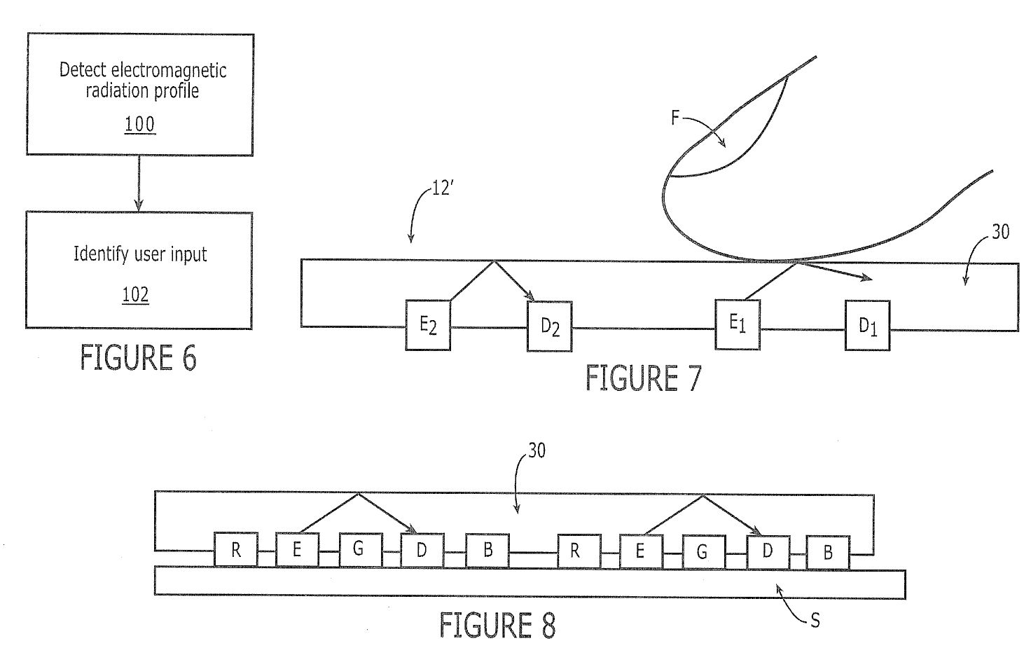

As illustrated in FIGS. 5A-5D and FIG. 6, the outputs of the electromagnetic radiation detector D can be used to generate a two dimensional image in response to the detected electromagnetic radiation profile (FIG. 5A; Block 100, FIG. 6), which can be used to identify a user input, such as a region of the display that is selected or highlighted by the user (FIG. 5D; Block 102, FIG. 6). In this configuration, a user input object, such as a finger or stylus, can be detected when the object is spaced apart and not in physical contact with the display 12.

For example, as shown in FIG. 5A, the data from the detectors D can be used to provide the image shown in FIG. 5A, which illustrates an exemplary infrared (IR) image of a user's finger. The contrast between the pixels of the image can optionally be enhanced as shown in FIG. 5B. The shape of the user's finger F can then be identified as shown in FIG. 5C. As shown in FIG. 5D, a target region T can then be identified, such as by using image analysis techniques known to those of skill in the art to identify a region from the shape of the finger F (e.g., the tip of the finger F). In some embodiments, the target region T may be indicated on the display 12 of FIGS. 1-4, e.g., by displaying an icon in the target region T. Thus, movement of the user input object or finger F can be tracked on the display 12 by displaying the icon responsive to movement of the finger F. In this configuration, various user inputs can be registered by the display without contact from the finger F.

In particular embodiments, the display 12 can further include a touch-sensitive display such that additional user inputs can be detected when a user input object contacts the display. In this configuration, user inputs to the display 12 may be used that are similar to those used in a conventional mouse environment. An icon, such as a traditional mouse arrow, can be moved when the user moves a user input object without contacting the display 12, such as is described with respect to FIGS. 5A-5D. When the user touches the display 12, another user input can be received by the mobile device 10 that may be analogous to selecting or “clicking” a mouse button at a particular location. Accordingly, the display 12 can detect motion and/or contact of a user input object to provide a user interface that is similar to a traditional mouse environment.

Although embodiments according to the present invention are described with respect to the infrared electromagnetic radiation emitters E and infrared electromagnetic radiation detectors D in FIG. 4, it should be understood that other suitable techniques can be used to provide an electromagnetic radiation profile responsive to a location of a user input object. For example, in some embodiments, the emitters E shown in FIG. 4 can be omitted, and the detectors D can be configured to detect an obstruction of background electromagnetic radiation responsive to a position of a user input object. In some embodiments, the electromagnetic radiation detectors D can be configured to detect thermal radiation, e.g., from a digit or finger of a user's hand, as an infrared (IR) signal.

According to further embodiments of the present invention, a touch-sensitive display system can be provided. As illustrated in FIG. 7, the display 12′ can include an array of electromagnetic radiation emitters E₁, E₂ electromagnetic radiation detectors D₁, D₂ and a refractive medium 30. In the absence of contact from a user input object, such as a finger F and as shown with respect to the emitter E₂ and detector D₂, the emitter E₂ is configured to emit electromagnetic radiation toward the refractive medium 30, and the total internal reflection of the refractive medium 30 reflects the electromagnetic radiation towards the detector D₂. The total internal reflection of the refractive medium 30 is disturbed or changed by contact from the finger F as shown with respect to the emitter E₁ and detector DJ such that the direction of reflected electromagnetic radiation is changed and the detector D₁ detects a reduced amount of electromagnetic radiation. The refractive medium 30 can be formed of any suitable material, including transparent and/or translucent plastic, elastomer materials, or glass. In some embodiments, the surface 30s can include a reflective or partially reflective coating. Thus, the presence of the finger F can be detected by a reduction or elimination of the detected electromagnetic radiation in detector D₁.

In some embodiments as shown in FIG. 8, the emitters E and detectors D can be provided on a substrate S together with light emitters R, G, B for red, green and blue light respectively. The light emitters R, G, B can be LEDs or OLEDs. Accordingly, the emitters E and/or detectors D can be integrated in the display.

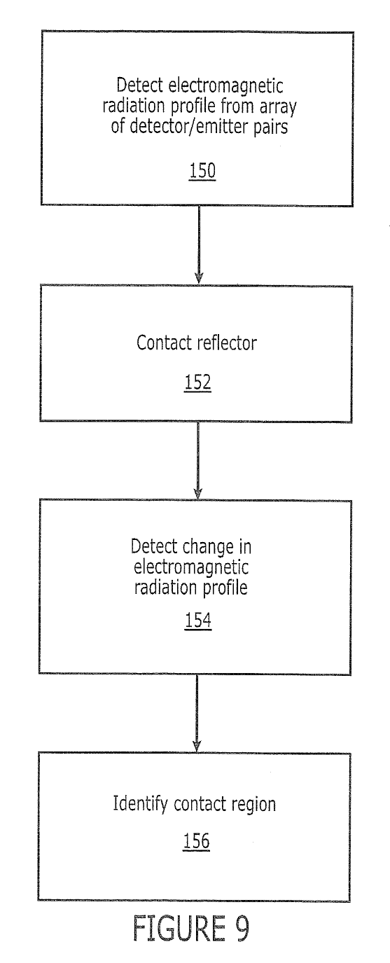

As illustrated in FIG. 9, the emitters E and detectors D can be used to detect an electromagnetic radiation profile of the display (Block 150), for example, by detecting an amount of electromagnetic radiation detected by an array of detectors D on the display 12′. The refractive medium of the display can be contacted (Block 152), and a resulting change in the electromagnetic radiation profile can be detected (Block 154). The contact region can be detected (Block 156), for example, based on an identification of the area in which the detectors detect a reduced amount of the reflected light.

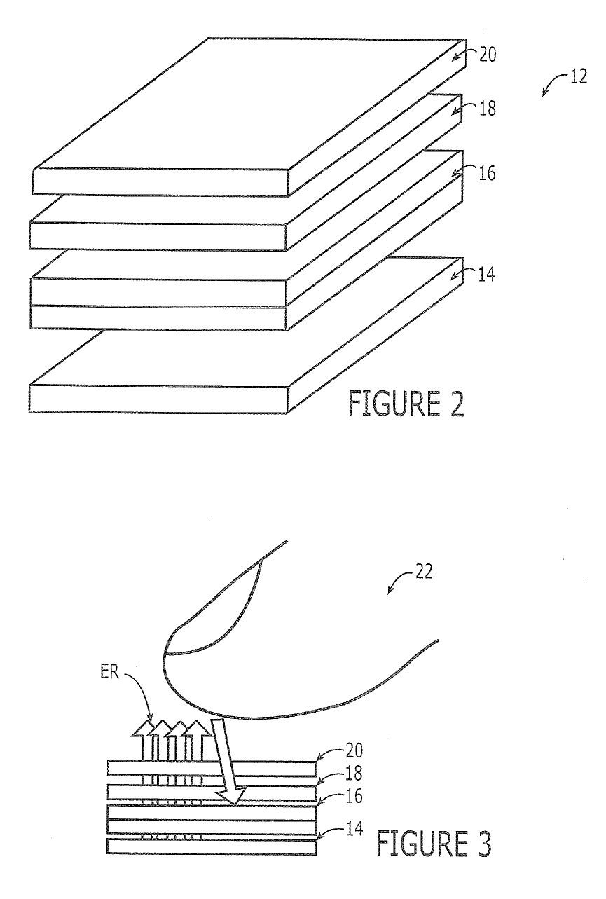

In particular embodiments, the configuration shown in FIGS. 7 and 8 can include additional emitters E and detectors D that are configured to detect a user input object that is not in contact with the display 12′ as is described with respect to FIGS. 2-6. The surface of the refractive medium 30 of FIGS. 7 and 8 can become reflective based on the incident angle of the electromagnetic radiation emitted by an emitter E (e.g., about 45 degrees for a plastic or glass and air interface). At other angles, the surface of the refractive medium 30 can be transmissive. Accordingly, the incident angles of the emitters E on the refractive medium 30 can be selected to provide both emitter E and detector D pairs that are configured as described with respect to FIGS. 7 and 8 (i.e., to detect reflected electromagnetic radiation and disruptions thereof by contact with the refractive medium 30) and emitters E that emit or transmit electromagnetic radiation through the refractive medium 30 as described with respect to FIGS. 2-6 (i.e. to detect user input objects that are spaced apart from the display 12, 12′).

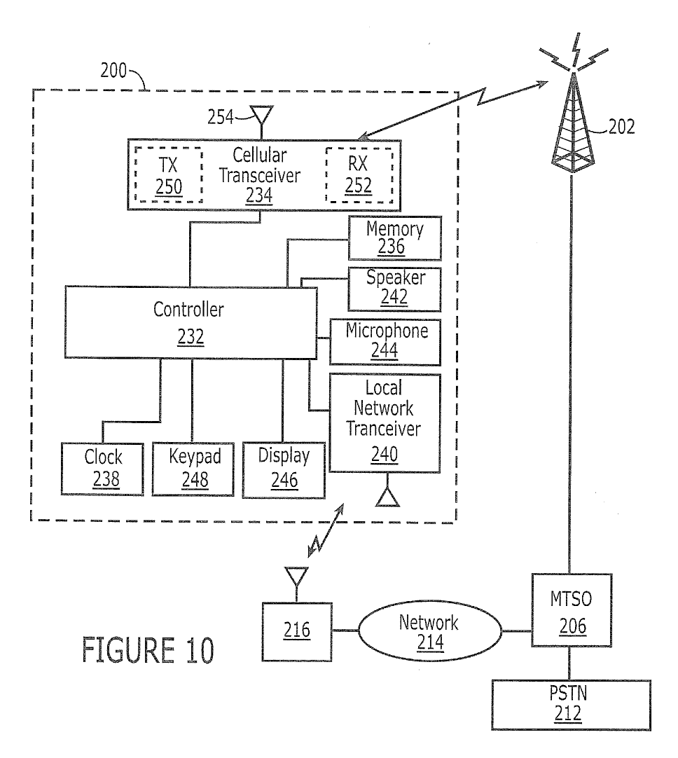

FIG. 10 is a schematic block diagram of a wireless communication system that includes a wireless terminal 200, such as a mobile wireless communications terminal, that receives wireless communication signals from a cellular base station 202 and/or a wireless local network 216. The cellular base station 202 is connected to a MTSO 206, which, in turn, is connected to a PSTN 212, and a network 214 (e.g., Internet). The mobile terminal 200 may communicate with the wireless local network 216 using a communication protocol that may include, but is not limited to, 802.11a, 802.11b, 802.11e, 802.11g, 802.11i, and/or other wireless local area network protocols. The wireless local network 216 may be connected to the network 214.

In some embodiments of the invention, the mobile terminal 200 includes a controller 232, a cellular transceiver 234, a memory 236, a timing circuit (clock) 238, a local network transceiver 240, a speaker 242, a microphone 244, a display 246 and a keypad 248. The display 246 can incorporate the elements of the displays 12, 12′ discussed herein.

The memory 236 stores software that is executed by the controller 232, and may include one or more erasable programmable read-only memories (EPROM or Flash EPROM), battery backed random access memory (RAM), magnetic, optical, or other digital storage device, and may be separate from, or at least partially within, the controller 232. The controller 232 may include more than one processor, such as, for example, a general purpose processor and a digital signal processor, which may be enclosed in a common package or separate and apart from one another.

In particular, the controller 232 may be configured to control operations as described with respect to FIGS. 1-9, for example, by identifying a user input from the electromagnetic radiation profile detected by the detectors D of the display 12, 12′.

The cellular transceiver 234 typically includes both a transmitter (TX) 250 and a receiver (RX) 252 to allow two way communications, but the present invention is not limited to such devices and, as used herein, a “transceiver” may include only the receiver 252. The mobile terminal 200 may thereby communicate with the base station 202 using radio frequency signals, which may be communicated through an antenna 254. For example, the mobile terminal 200 may be configured to communicate via the cellular transceiver 234 using one or more cellular communication, protocols such as, for example. Advanced Mobile Phone Service (AMPS), ANSI-1136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols as used herein may specify the information communicated, the timing, the frequency, the modulation, and/or the operations for setting-up and/or maintaining a communication connection. In some embodiments, the antennas 228 and 254 may be a single antenna.

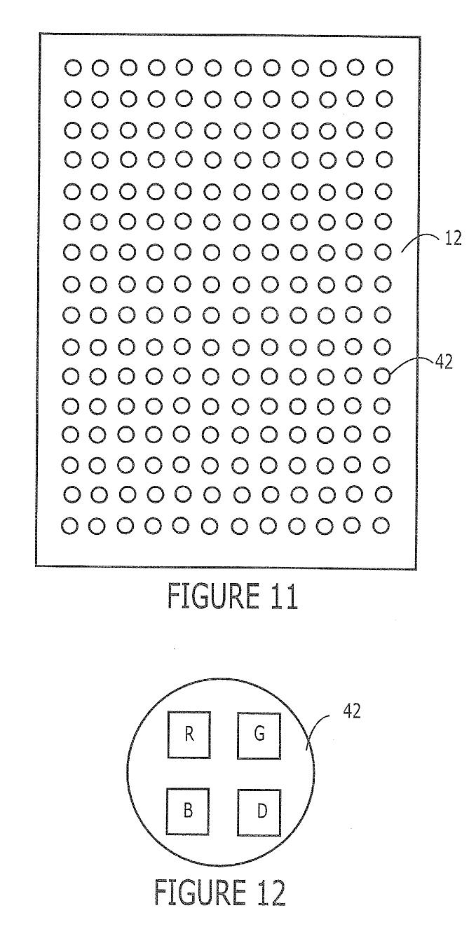

Further embodiments are illustrated in FIGS. 11 and 12. As shown therein, a display 12 may include a plurality of pixels 42, respective ones of which may include OLED and/or LED emitters R, G, B and an IR detector D. The outputs of the IR detectors D can be sampled to generate an image, such as the IR image illustrated in FIG. 5A, above. As noted above, the IR image can be processed using conventional image processing techniques to identify the presence of a user input object, such as a user's finger and/or a stylus. According to some embodiments, motions and/or actions by the user input object can be interpreted by the controller 232 as corresponding to various types of inputs or commands. Because the array of detectors D can sense motion of the user input object before it touches the display 12, the mobile terminal 200 can respond to other types of actions, or combinations of actions, besides touches or tough-based gestures. According to some embodiments, non-touch based gestures combined with touch-based gestures can be used to control operations of the mobile terminal 200.

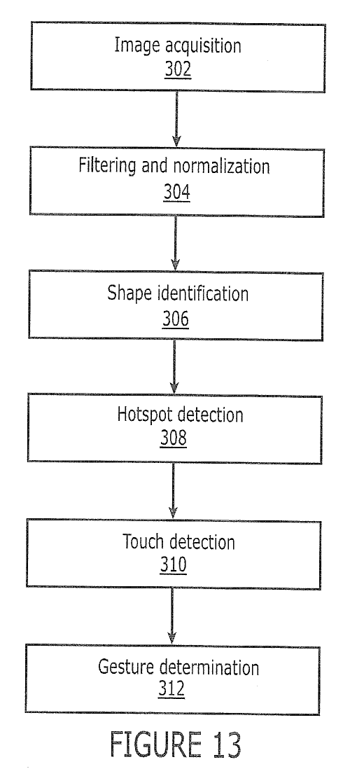

Gesture interpretation according to some embodiments may be more involved than gesture interpretation using a conventional touch-only touchpad. For example, FIG. 13 is a diagram illustrating gesture interpretation according to some embodiments. Blocks in the diagram of FIG. 13 may represent steps used in gesture interpretation by a mobile terminal 200 and may be implemented as functional modules in a software program executed by the controller 232 in the mobile terminal 200.

Referring to FIG. 13, gesture interpretation may include one or more of image acquisition (Block/module 302), image filtering and normalization (Block/module 304), shape identification (Block/module 306), hotspot detection (Block/module 308), touch detection (Block/module 310) and gesture determination (Block/module 312).

Image acquisition (Block/module 302) may be performed by sampling outputs of the IR detectors D and responsively generating a two-dimensional electromagnetic image. The generated image may be filtered and normalized (Block/module 304) to reduce noise, sharpen edges, highlight image features, or for other purposes. Shape identification (Block/module 306) uses pattern recognition to identify shapes in the image. In general, pattern recognition may involve feature extraction, in which numeric or symbolic information about an image is computed. A classification or description scheme classifies the extracted features. For example, features that can be extracted from an image can include scale-invariant and/or rotation-invariant features of the image. Object/image recognition techniques are well known to those skilled in the art and need not be described in detail herein.

Once a shape of a user input object, such as a user's finger, a stylus tip, etc., has been identified in the image, the location of a “hotspot” of the user input object is identified (Block/module 308). “Hotspot” refers to a point on the user input object at which contact between the user input object and the display screen 12 is expected, if the user were to touch the display 12 with the user input object. That is, even though the user input object (e.g., finger, stylus, etc.) is not in contact with the display 12, the operation of the mobile terminal 200 can be controlled in response to a location of the hotspot, as discussed in more detail below.

Hotspot determination can be performed using one or more heuristic and/or deterministic techniques. For example, a hotspot can be predicted/located based oil a determination that a particular identified user input object is a user's finger, a user's thumb, or a stylus or other artificial pointing device. Hotspot determination can also be performed based on calibration data. For example, a preliminary hotspot can be determined, and the user can then be asked to touch the screen. The location of the hotspot can then be adjusted based on a difference between the expected and actual locations of the touch on the screen.

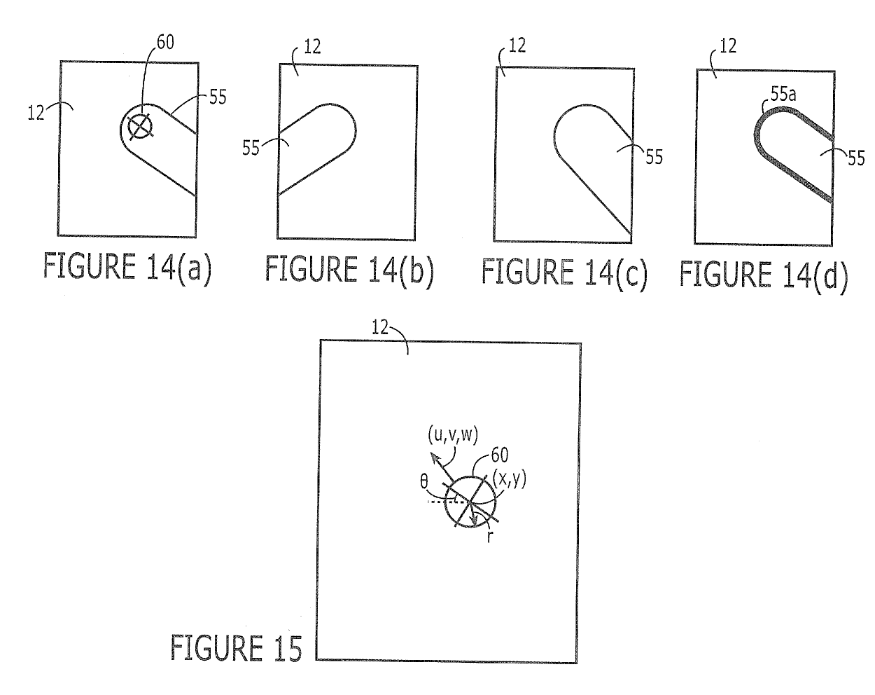

Shape determination is illustrated in more detail in FIG. 14. As shown therein, shape determination can be used to determine attributes of a user input object 55, such as shape (e.g., index finger, thumb or stylus), orientation (left or right hand), and distance to screen, as determined by edge blur. For example, as shown in FIG. 14(d), a user input object 55 that is held away from the screen can exhibit edge blurring 55a. The amount of edge blur can be interpreted as a measure of the distance of the user input object 55 from the display 12.

Referring to FIG. 14(a), a hotspot 60 is determined based on the location and orientation of the user input object 55. A hotspot 60 is shown in more detail in FIG. 15.

According to some embodiments, a mobile terminal 200 may include a hotspot detection module 308 that analyzes an image captured by the detectors D of the display 12. The hotspot detection module can identify and output various attributes of the hotspot, such as the shape (s), position (x,y), angular orientation (θ), radius (r), distance from display screen (z), and/or velocity vector (u,v,w). One or more gestures can be inferred in response to these attributes. In some embodiments, one or more gestures can be inferred in response to these attributes in combination with a touch on the touchscreen display 12.

The shape (s) refers to the type of shape detected as a user input object by the hotspot detection module 308, such as a finger, thumb, stylus, etc.

The position (x,y) represents the center of the hotspot 60. It may be determined based on knowledge of the type of shape that is used as a user input object. Once the shape has been identified, the hotspot detection module 308 can apply a heuristic or deterministic technique to locate the center of the hotspot 60 based on the type of shape. Furthermore, in some embodiments, different shapes can be used as user input objects to activate different functions in the mobile terminal 200. For example, a thumb shape can be used to activate different functionality than a finger shape in some embodiments. The hotspot center position defines the location on the display 12 that is activated by a particular gesture.

The hotspot center position (x,y) can be calibrated by instructing the user to touch a location on the display 12. The location may be any location on the display, or may be a predefined location, such as a location indicated by a graphic icon. The location of the touch is detected by the touchscreen function of the display 12, and the position of the hotspot center (x,y) relative to the shape (s) is determined.

The angular orientation (θ) may represent the angle of a major axis of the user input object relative to the orientation of the display screen 12. Knowing the angular orientation (θ) may permit more accurate hotspot determination. Furthermore, in some embodiments, different commands may be invoked based on the angular orientation of the user input object.

The size of the hotspot 60 is represented by the radius (r) of the hotspot 60. The radius represents the size of the portion of the user input object that is in contact with the display 12. For example, a finger may have a larger contact radius with the display screen 12 than a stylus. The radius of the hotspot 60 may be used to determine the activation area of effect of a gesture. In some embodiments, a probabilistic model that takes the size of the hotspot into account can be used to estimate or predict what area of the display screen 12 is being activated by the gesture.

The output (z) represents the distance of the user input object 55 to the display screen 12. By tracking a distance of the user input object to the display screen, gestures can be interpreted and used to invoke commands or actions in the mobile terminal 200 even if the user input object does not contact the display screen.

According to some embodiments, the distance (z) from the hotspot 60 to the screen 12 can be estimated by analyzing the relative blurriness of the edges of a tracked object. That is, the distance (z) may be estimated as a function of both the type/shape of object being tracked as well as the blurriness of the tracked object. Distance of the user input object from the display screen 12 can be used in some embodiments to invoke an image zoom function.

The velocity vector (u,v,w) of the hotspot tracks the velocity of the hotspot in the x- and y-directions (u and v) as well as the z-direction (w). The velocity (u,v,w) of the hotspot can be determined by calculating the distance covered from the last known hotspot coordinate. The velocity vector w in the z-direction can also take changes in the hotspot radius (r) into account when determining speed in the z-direction.

The display 12 also includes touchscreen capability, and the mobile terminal 200 is configured to determine when and where the screen 12 is touched by the user input object (Block/module 310). The display 12 may include a conventional touchscreen (e.g., resistive, capacitive, etc.) and/or may be configured as described above with respect to the embodiments of FIGS. 7 and 8 to detect a touch by a user input object.

Gesture determination can be based on one or more of the hotspot attributes output by the hotspot detection module 308. For example, the gestures shown in Table 1 below can be identified based on one or more hotspot attributes. As shown in Table 1, a gesture can be identified based on a pre-condition, a trigger, and a post condition. The combination of precondition, trigger, and post-condition signifies the occurrence of an event, which can be mapped to a feature or function in the mobile terminal 200. In Table 1, “HS” refers to “hotspot.” The “Event” column represents data that are passed from the gesture detection to a higher layer (e.g. the application layer). Depending on the gesture in question, different data may be available to the applications. The number “1” in the Event column indicates that there is one event. The symbol, “*” in the Event column indicates that there may be multiple events while the gesture is detected.

TABLE 1
Possible Gesture Detection Algorithms

| | | | | | Possible |
|---|---|---|---|---|---|
| | Pre- | | Post- | | Feature/ |
| Gesture | condition | Trigger | condition | Event | Function |
| Select | HS detected | display | HS detected | Touch (x, y) w 1 | Select |
| | | touched | | Untouch (x, y) 1 | |
| Click | HS detected | display | HS detected | Touch (x, y) w 1 | Select |
| | less than t_{click} | touched and | | Untouch (x, y) 1 | |
| | seconds ago | w > w_{click} | | | |
| Drag | HS detected + | HS moved | display | (x, y)-[u, v, w]* | Sort lists |
| | display | | touched | | |
| | touched | | | | |
| Track | HS detected | HS moved | HS detected | (x, y)-[u, v, w]* | Highlight |
| | | | | | items to be |
| | | | | | selected |
| 2^{nd} Select | HS detected + | 2^{nd} HS | HS detected + | Touch2 (x, y) 1 | Option menu |
| | display | detected | display | | |
| | touched | | touched | | |
| Flick | HS detected + | HS moved | display not | (x, y)-(u, v) 1 | Scroll |
| | display | quickly | touched | | |
| | touched | | | | |
| Pinch | two HS | two HS | one/two HS | (x1, y1), (x2, y2)* | Zoom in/out |
| | detected + | separation | detected + | | |
| | display | distance | display | | |
| | touched | changed | touched | | |
| Grab | two HS | display | display not | (x, y) | Cut/copy |
| | detected + | touched + two | touched | | |
| | display not | HS merge | | | |
| | touched | | | | |
| Drop | one HS | display | display not | (x, y) | Paste |
| | detected + | touched + one | touched | | |
| | display not | HS becomes | | | |
| | touched | two | | | |
| Sleep | no HS | Entire screen | no HS | | Go to standby |
| | detected + | covered with | detected | | |
| | display not | hand | | | |
| | touched | | | | |
| Wave | no HS | hand moved | no HS | (u, v) 1 | Next/previous |
| | detected + | in front of | detected | | page (vertical |
| | display not | screen from | | | wave) |
| | touched | one side to | | | Undo previous |
| | | another | | | action |
| | | | | | (horizontal |
| | | | | | wave) |
| Answer | display not | ear shape | none | (x, y) 1 | Answer call |
| | touched | detected | | | |

As can be seen from Table 1, three dimensional user input object tracking and gesture interpretation is a superset of two dimensional gesture interpretation that is familiar to users of touch pads and touch screens. However, three dimensional user input object tracking and gesture interpretation enables a wider variety of gestures to be implemented, including intuitive gestures, such as drag and drop.

Combining user input object tracking with algorithms to detect different gestures enables the creation and implementation of a wide range of unique user interface actions. For example, Table 1 defines both a “select” gesture as well as a “click” gesture. The “select” gesture is interpreted in response to detection of a hotspot (the pre-condition), followed by detection of a touch on the display (the triggering event), followed by detection of the hotspot again (the post-condition). The “click” gesture is interpreted in response to detection of a touch on the display with the velocity w in the z-direction exceeding a threshold velocity which (the triggering event), followed by detection of the hotspot again (the post-condition). Although these gestures can be similar, these gestures can have different effects. For example, a “select” gesture can be used to slowly select a small portion of the display screen, such as a hyperlink displayed on a web page, while the “click” gesture can be used to select a large lit area, such as a clickable button on the touchscreen.

The “tracking” gesture can provide better usability, for example in highly dense web pages wherein the actual link can be highlighted as with a mouse pointer, to give the user visual feedback of what portion of the display screen will be selected with a “select” gesture.

It will be appreciated that gestures can be different depending on the particular user input object used and/or the same gesture can activate different functions within the mobile terminal 200 depending on which user input object is used (e.g. finger versus thumb). Accordingly, it will be appreciated that in some embodiments, shapes can be used to trigger different events. Furthermore, shapes can be used to increase accuracy of the selection of intended targets.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A mobile device, comprising:
a touch-sensitive display screen including an array of electromagnetic radiation detectors, wherein the array of electromagnetic radiation detectors is configured to generate an image of a user input object when the user input object is spaced apart from the display and wherein the touch-sensitive display is further configured to generate a touch signal in response to the display screen being touched by the user input object; and
a controller configured to identify a hotspot on the user input object, wherein the hotspot comprises a portion of the user input object at which contact between the user input object and the display screen is expected, and to identify a user input gesture in response to a pre-condition, a trigger, and a post-condition, at least one of which includes detection of the hotspot while the user input object is spaced apart from the display screen and at least one other of which includes the touch signal.

2. The mobile device of claim 1, wherein the controller is further configured to identify at least one attribute of the hotspot, wherein the at least one attribute comprises at least one of a position, angular orientation, radius and velocity of the hotspot, and to identify the user input gesture in response to the at least one attribute of the hotspot.

3. The mobile device of claim 2, wherein the controller is further configured to identify a plurality of attributes of the hotspot, and to identify the user input gesture in response to the plurality of attributes of the hotspot.

4. The mobile device of claim 1, wherein the controller is further configured to identify a distance of the hotspot from the display screen, and wherein the controller is configured to estimate the distance of the hotspot from the display screen from the image of the user input object.

5. The mobile device of claim 4, wherein the controller is configured to measure an edge blurriness of the user input object in the image of the user input object, and wherein the controller is configured to estimate the distance of the hotspot from the display screen in response to the edge blurriness of the user input object.

6. The mobile device of claim 1, wherein the controller is configured to interpret a “select” command in response to a gesture including a precondition of a hotspot detection, a trigger of a touch signal indicating that the display screen was touched, and a postcondition of a hotspot detection.

7. The mobile device of claim 1, wherein the controller is configured to interpret a “click” command in response to a gesture including a precondition of detection of a hotspot within a first threshold t_{click} seconds before the display screen is touched, a trigger of the touch signal indicating that the display screen was touched with a velocity w in a direction normal to the screen greater than a second threshold w_{click}, and a postcondition of a hotspot detection.

8. The mobile device of claim 1, wherein the controller is configured to interpret a “drag” command in response to a gesture including a precondition of a hotspot detection and a first touch signal indicating that the display screen was touched, a trigger of movement of the hotspot, and a postcondition of a second touch signal indicating that the display screen continues to be touched.

9. The mobile device of claim 1, wherein the controller is configured to interpret a “track” command in response to a gesture including a precondition of a hotspot detection, a trigger of movement of the hotspot, and a postcondition of a hotspot detection.

10. The mobile device of claim 1, wherein the controller is configured to interpret a “flick” command in response to a gesture including a precondition of a hotspot detection and a first touch signal indicating that the display screen was touched, a trigger of movement of the hotspot with a horizontal velocity vector (u,v) larger than a threshold velocity, and a postcondition of a second touch signal indicating that the display screen is no longer touched.

11. The mobile device of claim 1, wherein the controller is configured to interpret a “grab” command in response to a gesture including a precondition of detection of two hotspots and a first touch signal indicating that the display screen was not touched, a trigger of movement of the two hotspots together, and a postcondition of a second touch signal indicating that the display screen is no longer touched.

12. The mobile device of claim 1, wherein the controller is configured to interpret a “drop” command in response to a gesture including a precondition of detection of one hotspot and a first touch signal indicating that the display screen was not touched, a trigger of separation of the single hotspot into two hotspots and a second touch signal indicating that the display screen is touched, and a postcondition of a third touch signal indicating that the display screen is no longer touched.

13. The mobile device of claim 1, wherein the controller is configured to interpret a “sleep” command in response to a gesture including a precondition of detection of no hotspots and the touch signal indicating that the display screen was not touched, a trigger of an the image indicating that the entire display screen has been covered by a user's hand, and a postcondition of detection of no hotspots.

14. The mobile device of claim 1, wherein the controller is configured to interpret a “wave” command in response to a gesture including a precondition of detection of no hotspots and the touch signal indicating that the display screen was not touched, a trigger of the image indicating that a hand was moved over the display screen from one side to another, and a postcondition of detection of no hotspots.

15. The mobile device of claim 1, wherein the controller is configured to interpret an “answer” command in response to a gesture including a precondition of the touch signal indicating that the display screen was not touched, and a trigger of the image indicating an ear adjacent to the display screen.

16. The mobile device of claim 1, wherein the controller is configured to interpret a “pinch” command in response to a gesture including a precondition of detection of two hotspots and a first touch signal indicating that the display screen was touched, a trigger of movement of the two hotspots toward each other so that a separation distance between the hotspots is reduced and a postcondition of detection of one or two hotspots and a second touch signal indicating that the display screen is still being touched.

17. A method for detecting user input on a touch-sensitive display screen, comprising:
generating an image of a user input object positioned adjacent to and spaced apart from the touch-sensitive display screen using an array of electromagnetic detectors in the display;
detecting a hotspot on the user input object, wherein the hotspot comprises a portion of the user input object at which contact between the user input object and the display screen is expected;
generating a touch signal in response to the user input object touching the display screen; and
identifying a user input in response to the image of the user input object and the touch signal; wherein identifying the user input comprises identifying the user input in response to a pre-condition, a trigger, and a post-condition, at least one of which includes detection of the hotspot while the user input object is spaced apart from the display screen and at least one other of which includes detection of the user input object touching on the display screen.

18. The method of claim 17, further comprising:
identifying a plurality of attributes of the hotspot, wherein identifying the user input is performed in response to the plurality of attributes of the hotspot.

19. The method of claim 17, further comprising identifying a distance of the user input object from the display screen by measuring an edge blurriness of the user input object in the image, and estimating the distance of the user input object from the display screen in response the edge blurriness of the user input object, wherein identifying the user input is performed in response to the distance of the user input object from the display screen.

20. A touch-sensitive display system comprising:
a touch-sensitive display screen including an array of electromagnetic radiation detectors, wherein the array of electromagnetic radiation detectors is configured to generate an image of a user input object when the user input object is spaced apart from the display, and wherein the touch-sensitive display is further configured to generate a touch signal in response to the display screen being touched by the user input object; and
a controller configured to identify a hotspot on the user input object, wherein the hotspot comprises a portion of the user input object at which contact between the user input object and the display screen is expected, and to identify a user input gesture in response to a pre-condition, a trigger, and a post-condition, at least one of which includes detection of the hotspot while the user input object is spaced apart from the display screen and at least one other of which includes the touch signal.
